(19) United States
(12) Patent Application Publication
(10) Pub. No.: US 2019/0303231 A1
(43) Pub. Date: Oct. 3, 2019

(54) LOG ANALYSIS METHOD, SYSTEM, AND PROGRAM

(71) Applicant: NEC Corporation, Minato-ku, Tokyo (JP)

(72) Inventor: Ryosuke TOGAWA, Tokyo (JP)

(73) Assignee: NEC Corporation, Minato-ku, Tokyo (JP)

(21) Appl. No.: 16/467,550

(22) PCT Filed: Dec. 27, 2016
(86) PCT No.: PCT/JP2016/005239

§ 371 Date: Jun. 7, 2019

(51) Int. Cl. G06F 11/07

(52) U.S. Cl. CPC G06F 11/0787; G06F 11/0721

(57) ABSTRACT

The present invention provides a log analysis method, a log analysis system, and a log analysis program that can cause multiple types of analysis to cooperate to analyze an anomaly of logs in a stepwise manner. The log analysis system according to one example embodiment of the present invention includes: a simple anomaly analysis unit that performs first analysis to detect an anomaly based on output of logs; and a detail anomaly analysis unit that performs second analysis to analyze the anomaly based on contents of the logs output within a time range including occurrence time of the anomaly detected by the first analysis.

### TECHNICAL FIELD

The present invention relates to a log analysis method, a log analysis system, and a log analysis program that analyze logs.

### Background Art

In systems executed on computers, in general, logs including a result of an event, a message, or the like are output. When a system anomaly or the like occurs, the output frequency and the content of logs may change compared to a normal state. Thus, various methods for detecting an anomaly based on the output frequency or the content of logs have been proposed.

The technology disclosed in Patent Literature 1 calculates an average and a standard deviation from a distribution of frequencies at which past logs (events) were output and generates a theoretical distribution (a normal distribution, a Poisson distribution, or the like) from the calculated average and standard deviation. This technology then determines based on the theoretical distribution whether or not an anomaly occurs from logs to be analyzed.

### CITATION LIST

### Patent Literature

PTL 1: Japanese Patent Application Laid-Open No. 2005-236862

### SUMMARY OF INVENTION

### Technical Problem

The technology disclosed in Patent Literature 1 detects occurrence of an anomaly based on a change in the output frequency of logs. In the technology disclosed in Patent Literature 1, however, it is not considered to further operate another log analysis method in corporation for analyzing a cause of the anomaly.

Further, when a plurality of log analysis methods are performed separately, a large number of notifications occur when an anomaly occurs. Thus, the user may receive a large number of notifications at the same time, it is difficult to promptly address and analyze the anomaly.

### Solution to Problem

The present invention has been made in view of the problems described above and intends to provide a log analysis method, a log analysis system, and a log analysis program that can operate multiple types of analysis in cooperation in order to analyze an anomaly of logs in a stepwise manner.

The first example aspect of the present invention is a log analysis method including steps of: performing first analysis to detect an anomaly based on output of logs; and performing second analysis to analyze the anomaly based on contents of the logs output within a time range including occurrence time of the anomaly detected by the first analysis.

The second example aspect of the present invention is a log analysis program that causes a computer to perform steps of: performing first analysis to detect an anomaly based on output of logs; and performing second analysis to analyze the anomaly based on contents of the logs output within a time range including occurrence time of the anomaly detected by the first analysis.

The third example aspect of the present invention is a log analysis system including: a simple anomaly analysis unit that performs first analysis to detect an anomaly based on output of logs; and a detail anomaly analysis unit that performs second analysis to analyze the anomaly based on contents of the logs output within a time range including occurrence time of the anomaly detected by the first analysis.

### Advantageous Effects of Invention

According to the present invention, since first analysis based on output of logs is performed and then second analysis based on detailed contents of logs is performed by using a result of the first analysis, it is possible to cause multiple types of analysis to cooperate to analyze an anomaly of logs in a stepwise manner.

### BRIEF DESCRIPTION OF DRAWINGS

FIG. 1 is a block diagram of a log analysis system according to a first example embodiment.

FIG. 2 is a schematic diagram of an analysis target log according to the first example embodiment.

FIG. 3 is a schematic diagram of a format according to the first example embodiment.

FIG. 4 is a schematic diagram of a log analysis method according to the first example embodiment.

FIG. 5 is a schematic configuration diagram of a log analysis system according to the first example embodiment.

FIG. 6 is diagram illustrating a flowchart of a log analysis method according to the first example embodiment.

FIG. 7 is a block diagram of a log analysis system according to a second example embodiment.

FIG. 8 is a schematic diagram of a log analysis method according to the second example embodiment.

FIG. 9 is a schematic diagram of a log analysis method according to a third example embodiment.

FIG. 10 is a schematic diagram of a log analysis method according to the third example embodiment.

FIG. 11 is a block diagram of a log analysis system according to each example embodiment.

### DESCRIPTION OF EMBODIMENTS

While example embodiments of the present invention will be described below with reference to the drawings, the present invention is not limited to the present example embodiments. Note that, in the drawings described below, components having the same function are labeled with the same reference symbols, and the duplicated description thereof may be omitted.

### First Example Embodiment

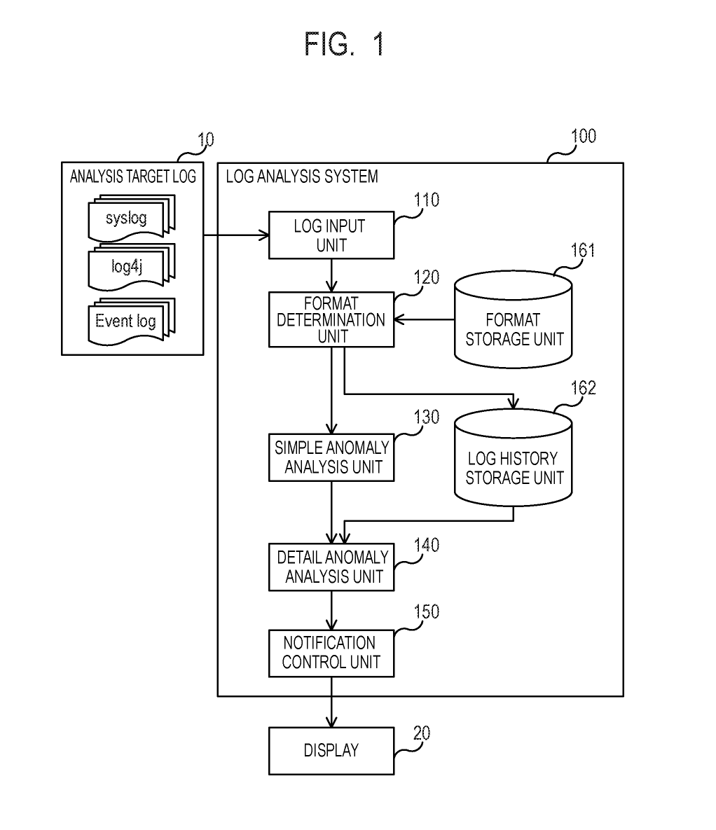

FIG. 1 is a block diagram of a log analysis system 100 according to the present example embodiment. In FIG. 1, arrows represent main dataflows, and there may be other dataflows than those illustrated in FIG. 1. In FIG. 1, each block illustrates a configuration in a unit of function rather than in a unit of hardware (device). Therefore, the block shown in FIG. 1 may be implemented in a single device or may be implemented independently in a plurality of devices. Transmission and reception of the data between blocks may be performed via any means, such as a data bus, a network, a portable storage medium, or the like.

The log analysis system 100 includes, as a processing unit, a log input unit 110, a format determination unit 120, a simple anomaly analysis unit 130, a detail anomaly analysis unit 140, and a notification control unit 150. Further, the log analysis system 100 includes, as a storage unit, a format storage unit 161 and a log history storage unit 162.

The log input unit 110 receives an analysis target log 10 to be an analysis target and inputs the received analysis target log 10 into the log analysis system 100. The analysis target log 10 may be acquired from the outside of the log analysis system 100 or may be acquired by reading pre-stored logs inside the log analysis system 100. The analysis target log 10 includes one or more logs output from one or more devices or programs. The analysis target log 10 is a log represented in any data form (file form), which may be, for example, binary data or text data. Further, the analysis target log 10 may be stored as a table of a database or may be stored as a text file.

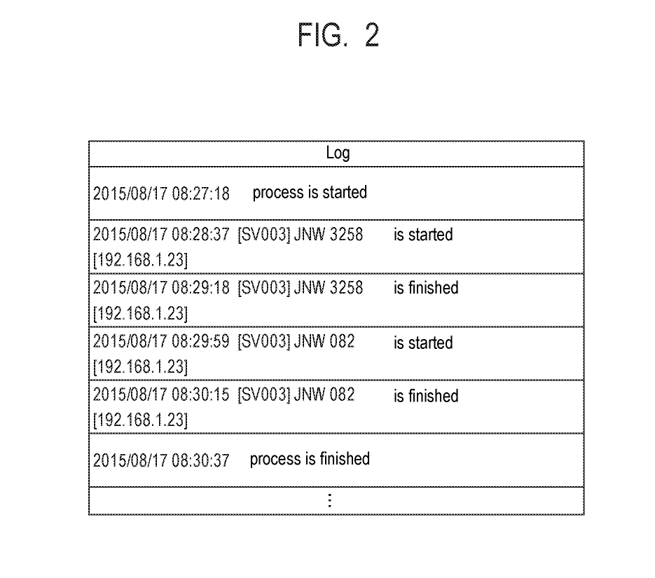

FIG. 2 is a schematic diagram of an exemplary analysis target log 10. The analysis target log 10 according to the present example embodiment includes any number of one or more logs, where one log output from a device or a program is defined as one unit. One log may be one line of character string or two or more lines of character strings. That is, the analysis target log 10 refers to the entire logs included in the analysis target log 10, and a log refers to a single log extracted from the analysis target log 10. Each log includes a time stamp, a message, and the like. The log analysis system 100 can analyze not only a specific type of logs but also broad types of logs. For example, any log that records a message output from an operating system, an application, or the like, such as syslog, an event log, or like, can be used as the analysis target log 10.

The format determination unit 120 determines which format (form) pre-stored in the format storage unit 161 each log included in the analysis target log 10 conforms to and divides each log into a variable part and a constant part by using the conforming format. The log on which format determination has been performed is stored in a log history storage unit 162 together with information indicating the determined format. The format is a predetermined form of a log based on characteristics of the log. The characteristics of the log include a property of being likely to vary or less likely to vary between logs similar to each other or a property of having description of a character string considered as a part which is likely to vary in the log. The variable part is a part that may vary in the format, and the constant part is a part that does not vary in the format. The value (including a numerical value, a character string, and other data) of the variable part in the input log is referred to as a variable value. The variable part and the constant part are different on a format basis. Thus, there is a possibility that the part defined as the variable part in a certain format is defined as the constant part in another format or vice versa.

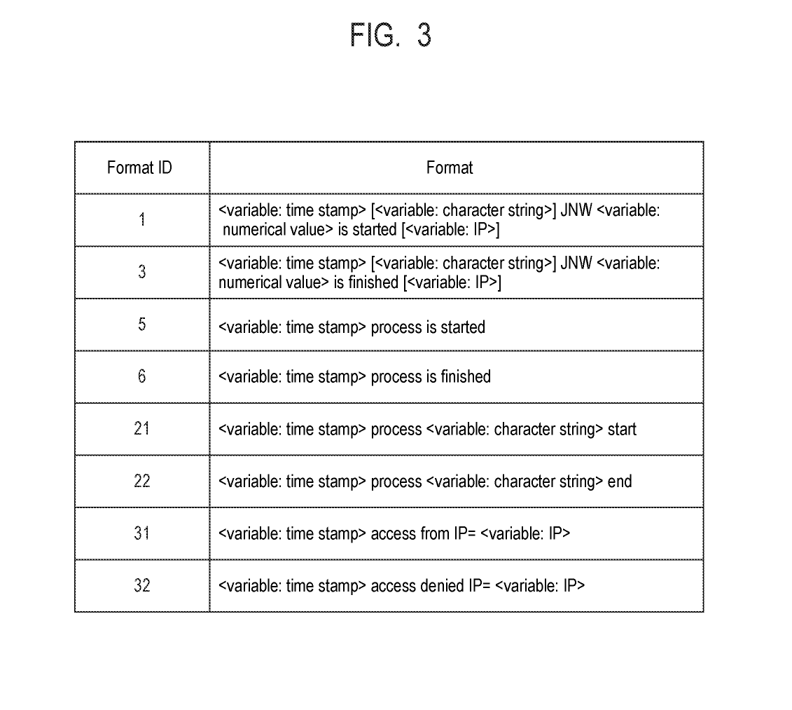

FIG. 3 is a schematic diagram of an exemplary format stored in the format storage unit 161. A format includes a character string representing a format associated with a unique format ID. By describing a predetermined identifier in a part, which may vary, of a log, the format defines the variable part and defines the part of the log other than the variable part as the constant part. As an identifier of the variable part, for example, “<variable: time stamp>” indicates the variable part representing a time stamp, “<variable: character string>” indicates the variable part representing any character string, “<variable: numerical value>” indicates the variable part representing any numerical value, and “<variable: IP>” indicates the variable part representing any IP address. The identifier of a variable part is not limited thereto but may be defined by any method such as a regular expression, a list of values which may be taken, or the like. A format may be formed of only the variable part without including the constant part or only the constant part without including the variable part.

For example, the format determination unit 120 determines that the log on the third line of FIG. 2 conforms the format whose ID of FIG. 3 is 1. Then, the format determination unit 120 processes the log based on the determined format and determines “2015/08/17 08:28:37”, which is time stamp, “SV003”, which is the character string, “3258”, which is the numerical value, and “192.168.1.23”, which is the IP address, as variable values.

In FIG. 3, although the format is represented by the list of character strings for better visibility, the format may be represented in any data form (file form), for example, binary data or text data. Further, a format may be stored in the format storage unit 161 as a binary file or a text file or may be stored in the format storage unit 161 as a table of a database.

The simple anomaly analysis unit 130 and the detail anomaly analysis unit 140 detect and analyze an anomaly in two steps with respect to the analysis target log 10 by using a log analysis method described below.

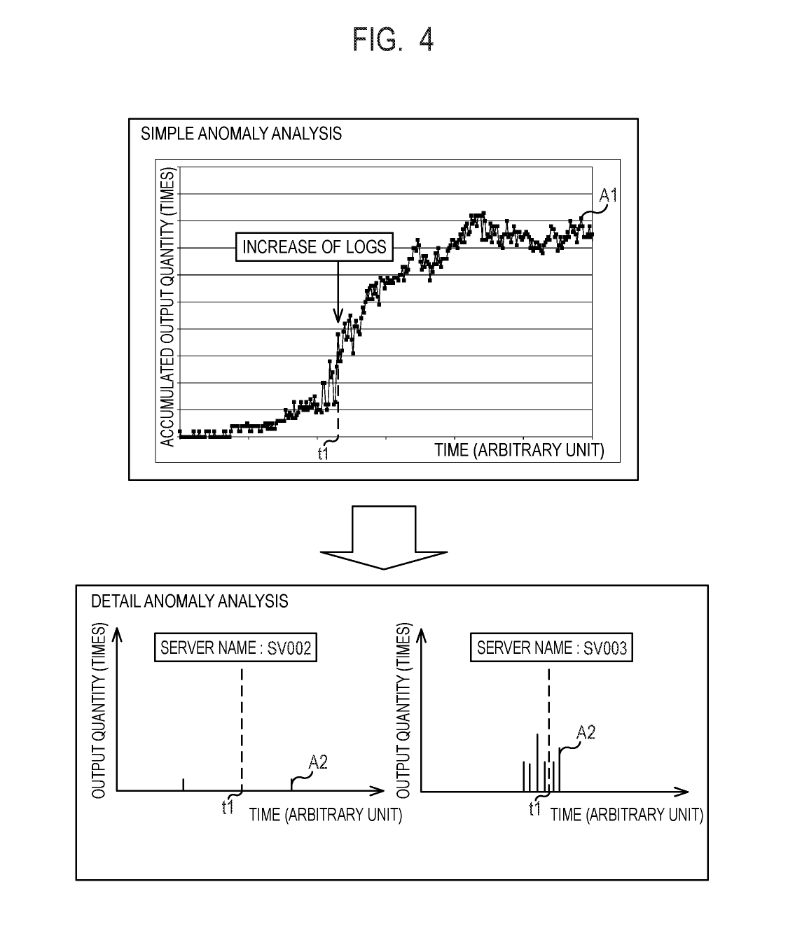

FIG. 4 is a schematic diagram of a log analysis method according to the present example embodiment. First, the simple anomaly analysis unit 130 performs simple anomaly analysis (first analysis) on the analysis target log 10 and detects occurrence of an anomaly and the time of the occurrence. The simple anomaly analysis is analysis that detects an anomaly by using a time-series change of log output, such as a change in trend of the output quantity of logs in the analysis target log 10.

Specifically, the simple anomaly analysis unit 130 generates a distribution Al of an accumulated output quantity resulted by summing the number of logs output by each time (time of day) included in the analysis target log 10. An accumulated output quantity may be the output quantity of logs of a single format, may be the sum of the output quantity of a plurality of the formats, or may be the sum of the output quantity of logs of all the formats. The simple anomaly analysis unit 130 then detects time at which the accumulated output quantity sharply increases as anomaly detection time t1 from the distribution A1 of the accumulated output quantity. A sharp increase in an accumulated output quantity is detected from an instance that the increment or the increase rate of the accumulated output quantity occurring from a certain time to the next time is greater than or equal to a predetermined threshold, for example. The threshold is appropriately determined by an experiment or a simulation. Instead of an accumulated output quantity, an output frequency per unit time may be used for the simple anomaly analysis.

When an anomaly is detected by the simple anomaly analysis unit 130, the detail anomaly analysis unit 140 reads logs output within a predetermined time range including the anomaly detection time t1 detected by the simple anomaly analysis unit 130 from the log history storage unit 162 to perform detail anomaly analysis (second analysis) and detects information indicating a cause of the anomaly. The detail anomaly analysis is analysis to detect an anomaly by using the content of a log, such as a variable value or the like included in a log in the analysis target log 10.

Specifically, the detail anomaly analysis unit 140 acquires, from the log history storage unit 162, logs and the formats thereof corresponding to a first time range (for example, 12 hours around the anomaly detection time t1) around the anomaly detection time t1 detected by the simple anomaly analysis unit 130 and generates a distribution A2 of the output quantity of logs for each variable value included in the acquired logs. In the example of FIG. 4, while a server name is used as a variable, any variable that may correspond to a cause of an anomaly, such as a file name, an IP address, or the like may be used to generate the distribution A2 for each variable value.

The detail anomaly analysis unit 140 detects, from the distribution A2 for each variable value, a variable value for which the output quantity increases around the anomaly detection time t1 (the server name “SV003” in this example) as information indicating a cause of an anomaly. An increase in the output quantity is detected from an instance that the increment or the increase rate of the average output quantity in a second time range (for example, 1 hour around the anomaly detection time t1) around the anomaly detection time t1 with respect to the average output quantity in the first time rage (for example, 12 hours around the anomaly detection time t1) around the anomaly detection time t1 is greater than or equal to a predetermined threshold, for example. Here, the second time range is set to be shorter than the first time range. Thereby, it is possible to detect temporary or irregular output of logs around occurrence of an anomaly rather than periodical or regular output of logs. For detail anomaly analysis, an output frequency per unit time may be used instead of an output quantity.

The notification control unit 150 performs control to use a display 20 to provide notification of information indicating an anomaly (for example, the time when the anomaly is detected, logs generated around the time, and information indicating a cause of the anomaly) detected by the simple anomaly analysis unit 130 and the detail anomaly analysis unit 140. The notification of an anomaly by the notification control unit 150 may be performed by any method that can notify the user, such as printing by using a printer, audio output by using a speaker, or the like, without being limited to display by using the display 20.

In the simple anomaly analysis, since an anomaly is detected based on output of logs (the output quantity of logs or a time-series change in the output frequency of logs in this example), calculation cost is low. On the other hand, in the detail anomaly analysis, since detailed analysis of the content of logs (variable values included in logs in this example) is performed, while detailed analysis of an anomaly can be performed, the calculation cost is higher than in the simple anomaly analysis. Thus, the present example embodiment performs the simple anomaly analysis that detects an anomaly based on output of logs and then performs the detail anomaly analysis that analyzes the anomaly based on the content of logs output within a predetermined time range including occurrence time of the anomaly detected by the simple anomaly analysis. That is, in the present example embodiment, it is possible to perform detailed analysis of an anomaly while reducing calculation cost by performing the simple anomaly analysis to reduce the analysis range to be targeted by the detail anomaly analysis. Further, since the detail anomaly analysis is performed on only the analysis range reduced by the simple anomaly analysis, the number of unnecessary notifications for an anomaly can be smaller than when the simple anomaly analysis and the detail anomaly analysis are separately performed.

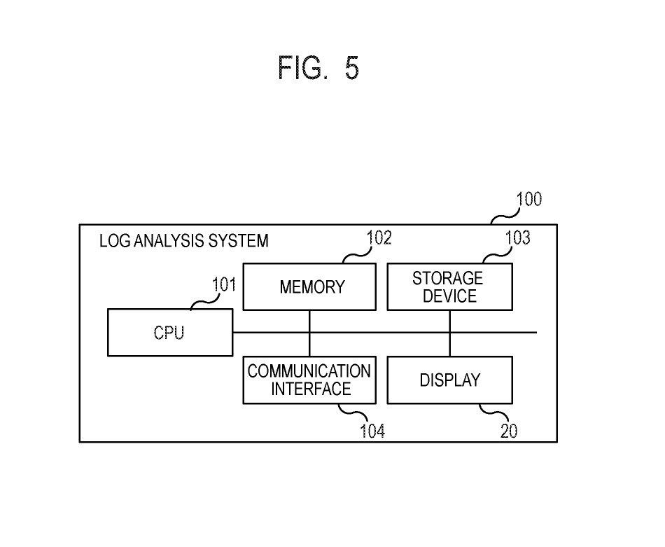

FIG. 5 is a schematic configuration diagram illustrating an exemplary device configuration of the log analysis system 100 according to the present example embodiment. The log analysis system 100 includes a central processing unit (CPU) 101, a memory 102, a storage device 103, a communication interface 104, and the display 20. The log analysis system 100 may be a separate device or may be integrally configured with another device.

The communication interface 104 is a communication unit that transmits and receives data and is configured to be able to execute at least one of the communication schemes of wired communication and wireless communication. The communication interface 104 includes a processor, an electric circuit, an antenna, a connection terminal, or the like required for the above communication scheme. The communication interface 104 is connected to a network using the communication scheme in accordance with a signal from the CPU 101 for communication. The communication interface 104 externally receives the analysis target log 10, for example.

The storage device 103 stores a program executed by the log analysis system 100, data of a process result obtained by the program, or the like. The storage device 103 includes a read only memory (ROM) dedicated to reading, a hard disk drive or a flash memory that is readable and writable, or the like. Further, the storage device 103 may include a computer readable portable storage medium such as a CD-ROM. The memory 102 includes a random access memory (RAM) or the like that temporarily stores data being processed by the CPU 101 or a program and data read from the storage device 103.

The CPU 101 is a processor that temporarily stores temporary data used for processing in the memory 102, reads a program stored in the storage device 103, and executes various processing operations such as calculation, control, determination, or the like on the temporary data in accordance with the program. Further, the CPU 101 stores data of a process result in the storage device 103 and also transmits data of the process result externally via the communication interface 104.

In the present example embodiment, the CPU 101 functions as the log input unit 110, the format determination unit 120, the simple anomaly analysis unit 130, the detail anomaly analysis unit 140, and the notification control unit 150 of FIG. 1 by executing a program stored in the storage device 103. Further, in the present example embodiment, the storage device 103 functions as the format storage unit 161 and the log history storage unit 162 of FIG. 1.

The display 20 is a display device that displays information to the user. Any display device such as a cathode ray tube (CRT) display, a liquid crystal display, or the like may be used as the display 20. The display 20 displays predetermined information in accordance with a signal from the CPU 101.

The log analysis system 100 is not limited to the specific configuration illustrated in FIG. 5. The log analysis system 100 is not limited to a single device and may be configured such that two or more physically separated devices are connected by wired or wireless connection. Respective units included in the log analysis system 100 may be implemented by an electric circuitry, respectively. The electric circuitry here is a term conceptually including a single device, multiple devices, a chipset, or a cloud.

Further, at least a part of the log analysis system 100 may be provided in a form of Software as a Service (SaaS). That is, at least some of the functions for implementing the log analysis system 100 may be executed by software executed via a network.

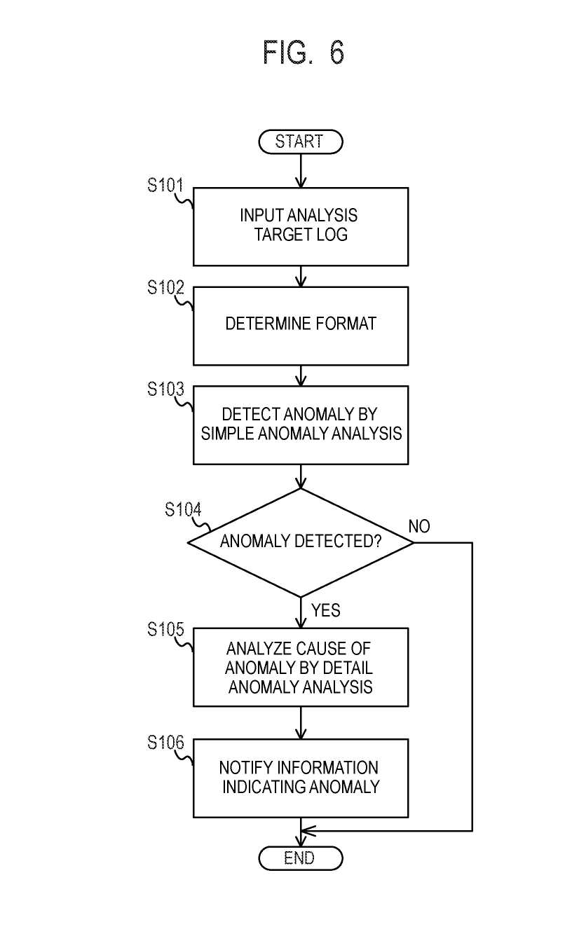

FIG. 6 is a diagram illustrating a flowchart of a log analysis method using the log analysis system 100 according to the present example embodiment. The flowchart of FIG. 6 is started by the user performing a predetermined operation to perform log analysis on the log analysis system 100, for example. First, the log input unit 110 receives the analysis target log 10 and inputs the received analysis target log 10 to the log analysis system 100 (step S101). The format determination unit 120 determines which format stored in the format storage unit 161 each log included in the analysis target log 10 input in step S101 conforms to (step S102). The format determination unit 120 stores, in the log history storage unit 162, each log included in the analysis target log 10 on which the format determination is performed together with information indicating the determined format.

Next, the simple anomaly analysis unit 130 performs the simple anomaly analysis described above (first analysis) on the logs whose format has been determined in step S102 and detects occurrence of an anomaly and the time thereof (step S103).

If an anomaly is detected by the simple anomaly analysis unit 130 (step S104, YES), the detail anomaly analysis unit 140 performs the detail anomaly analysis described above (second analysis) on logs within a predetermined time range including the anomaly detection time detected in step S103 out of logs whose formats have been determined in step S102, analyzes a cause of the anomaly, and detects information indicating the cause of the anomaly (step S105).

The notification control unit 150 performs control to use the display 20 to provide notification of information indicating an anomaly (for example, the time when the anomaly is detected, logs generated around the time, and information indicating a cause of the anomaly) detected in steps S103 and S105 (step S106). After the notification is performed in step S106 or if no anomaly is detected in step S103 (step S104, NO), the log analysis method ends.

The CPU 101 of the log analysis system 100 is a subject of each step (process) included in the log analysis method illustrated in FIG. 6. That is, the CPU 101 performs the log analysis method illustrated in FIG. 6 by reading the program used for executing the log analysis method illustrated in FIG. 6 from the memory 102 or the storage device 103, executing the program, and controlling each unit of the log analysis system 100.

Conventionally, it is not expected to perform a plurality of log analysis methods in cooperation. When a plurality of log analysis methods that perform different types of analysis are separately performed, there is a likelihood that unnecessary calculation cost occurs or a large number of notifications occur from respective log analysis methods at the time of occurrence of an anomaly. With such occurrence of a large number of notifications, the user has to determine the importance of each notification, which increases a burden on the user operation. In contrast, in the present example embodiment, by performing the simple anomaly analysis to reduce the analysis range to be targeted by the detail anomaly analysis, it is possible to perform detail analysis of an anomaly while reducing calculation cost. Further, since the detail anomaly analysis is performed on only the analysis range reduced by the simple anomaly analysis, the number of unnecessary notifications for an anomaly can be smaller than when the simple anomaly analysis and the detail anomaly analysis are separately performed.

### Second Example Embodiment

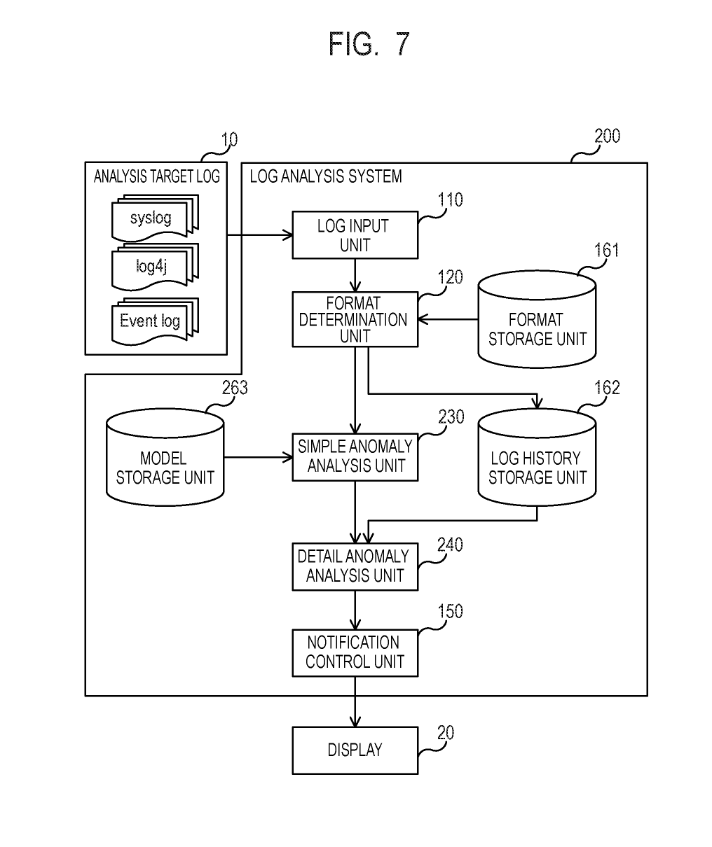

In the present example embodiment, simple anomaly analysis and detail anomaly analysis are performed by using a different scheme from the first example embodiment. FIG. 7 is a block diagram of a log analysis system 200 according to the present example embodiment. The log analysis system 200 includes a model storage unit 263 as the storage unit in addition to the configuration of the log analysis system 100 of FIG. 1 and is different in the operation of the simple anomaly analysis performed by the simple anomaly analysis unit 230 and the detail anomaly analysis performed by the detail anomaly analysis unit 240. Only the portions different from the first example embodiment will be described below.

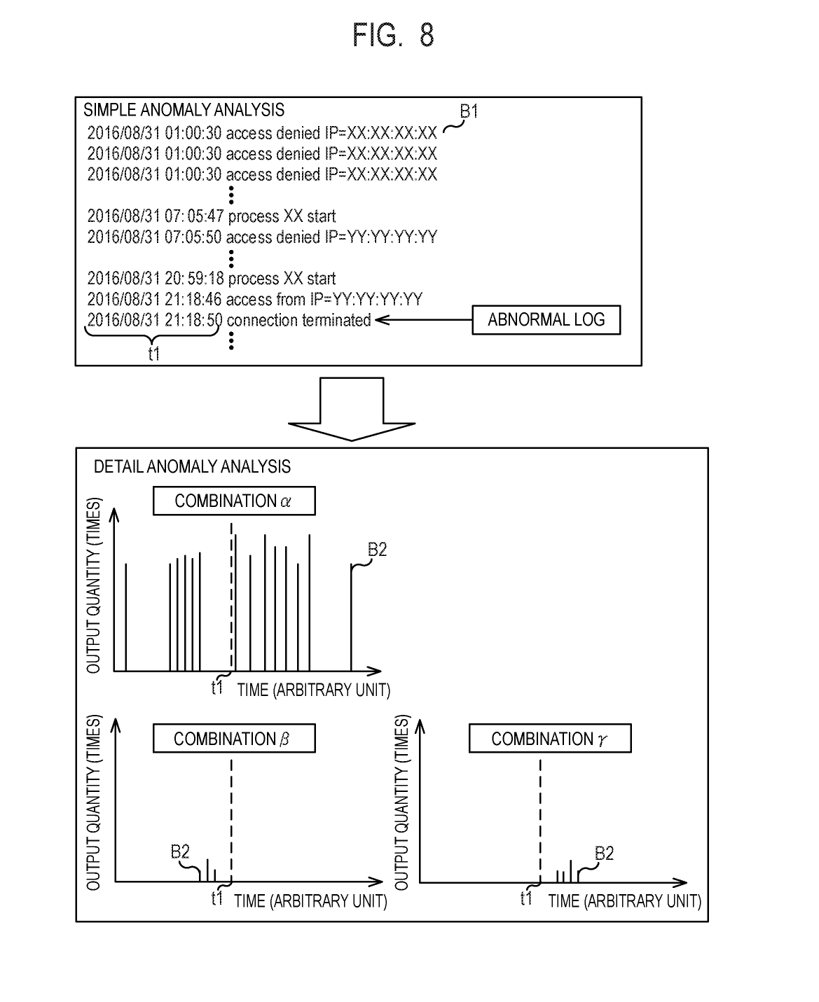

FIG. 8 is a schematic diagram of a log analysis method according to the present example embodiment. First, the simple anomaly analysis unit 230 performs the simple anomaly analysis (first analysis) on the analysis target log 10 and detects occurrence of an anomaly and the time thereof.

Specifically, the simple anomaly analysis unit 230 determines whether or not each log B1 included in the analysis target log 10 corresponds to any of the models indicating at least one of the format and the variable value pre-stored in the model storage unit 263. That is, the simple anomaly analysis unit 230 determines that a log B1 is normal if the format and the variable value of the log B1 match the format and the variable value of any of the models stored in the model storage unit 263 and determines that a log B1 is abnormal if neither the format nor the variable value of the log B1 matches the format and the variable value of any of the models. The simple anomaly analysis unit 230 then detects, as the anomaly detection time t1, the time when the abnormal log B1 is output. The determination of an anomaly of logs based on such a model is performed with low calculation cost and thus may be used as the simple anomaly analysis.

In the model storage unit 263, models indicating combinations each including a normal format and a variable value are pre-stored. The model stored in the model storage unit 263 may be defined by at least one of a format and a variable value without being limited to the combination of a format and a variable value. That is, for a model indicating only the format, the simple anomaly analysis unit 230 determines a normal state or an abnormal state in accordance with whether or not the format of a log included in the analysis target log 10 matches a format of any of the models. For a model indicating only the variable value, the simple anomaly analysis unit 230 determines a normal state or an abnormal state in accordance with whether or not a log included in the analysis target log 10 includes the variable value of any of the models.

When an anomaly is detected by the simple anomaly analysis unit 230, the detail anomaly analysis unit 240 reads logs output within a predetermined time range including the anomaly detection time t1 detected by the simple anomaly analysis unit 230 from the log history storage unit 162 to perform detail anomaly analysis (second analysis) and detects information indicating a cause of the anomaly.

Specifically, the detail anomaly analysis unit 240 acquires, from the log history storage unit 162, logs and the formats thereof corresponding to the first time range (for example, 12 hours around the anomaly detection time t1) around the anomaly detection time t1 detected by the simple anomaly analysis unit 230 from the analysis target log 10 stored in the log history storage unit 162. The detail anomaly analysis unit 240 then separates the acquired logs into respective combinations each including a format and a variable value and generates a distribution B2 of an output quantity of logs for each combination of a format and a variable value.

For example, in the example of FIG. 8, the distribution B2 is generated for combinations α, β, and γ each including a format and a variable value. For example, the combination α is a combination of a format ID of “1” and a variable value of “SV002”, the combination β is a combination of a format ID of “1” and a variable value of “SV003”, and the combination γ is a combination of a format ID of “3” and a variable value of “SV003”. Without being limited to the above, the distribution B2 may be generated for any combination of a format and a variable value. The distribution B2 may be generated for all the combinations each including a format and a variable or may be generated for some of the combinations which satisfy a predetermined condition (for example, include a variable value indicating a server name).

The detail anomaly analysis unit 240 then detects, as information indicating a cause of an anomaly, a combination which has the increased output quantity around the anomaly detection time t1 out of the distribution B2 for each combination. An increase in the output quantity is detected from an instance that the increment or the increase rate of the average output quantity in a second time range (for example, 1 hour around the anomaly detection time t1) around the anomaly detection time t1 with respect to the average output quantity in the first time rage (for example, 12 hours around the anomaly detection time t1) around the anomaly detection time t1 is greater than or equal to a predetermined threshold, for example. Here, the second time range is set to be shorter than the first time range. Thereby, it is possible to detect temporary or irregular output of logs around occurrence of an anomaly rather than periodical or regular output of logs. For detail anomaly analysis, an output frequency per unit time may be used instead of an output quantity. Further, the detail anomaly analysis may be performed by using a cycle of logs by which an output quantity or an output frequency logs on multiple dates are collected for every time of a day rather than the output quantity or the output frequency for every time including the date and time.

The notification control unit 150 performs control to use the display 20 to provide notification of information indicating an anomaly (for example, the time when the anomaly is detected, logs generated around the time, and information indicating a cause of the anomaly) detected by the simple anomaly analysis unit 230 and the detail anomaly analysis unit 240. The notification of an anomaly by the notification control unit 150 may be performed by any method that can notify the user, such as printing by using a printer, audio output by using a speaker, or the like, without being limited to display by using the display 20.

Also in the present example embodiment, since an anomaly is detected based on output of logs (output of logs which do not match the normal model in this example) in the simple anomaly analysis as with the first example embodiment, calculation cost is low. On the other hand, while detailed analysis of an anomaly can be performed because detailed factor analysis of the content of logs (a combination of a format of the log and a variable value included in the log) is performed in the detail anomaly analysis, the calculation cost is higher than in the simple anomaly analysis. Thus, the present example embodiment performs the simple anomaly analysis that detects an anomaly based on output of logs and then performs the detail anomaly analysis based on the content of logs output within a predetermined time range including occurrence time of the anomaly detected by the simple anomaly analysis. That is, in the present example embodiment, it is possible to perform detailed analysis of an anomaly while reducing calculation cost by performing the simple anomaly analysis to reduce the analysis range to be targeted by the detail anomaly analysis. Further, since the detail anomaly analysis is performed on only the analysis range reduced by the simple anomaly analysis, the number of unnecessary notifications for an anomaly can be smaller than when the simple anomaly analysis and the detail anomaly analysis are separately performed. Furthermore, since detection is performed by generating a distribution separated for each combination of a format and a variable, information indicating a cause of an anomaly can be detected based on the feature of a hidden distribution behind the distribution of only variable values.

### Third Example Embodiment

The present example embodiment provides a method for detecting information indicating a cause of an anomaly from a distribution of logs in the detail anomaly analysis of the second example embodiment. The method of the present example embodiment is utilized in the log analysis system 200 according to the second example embodiment.

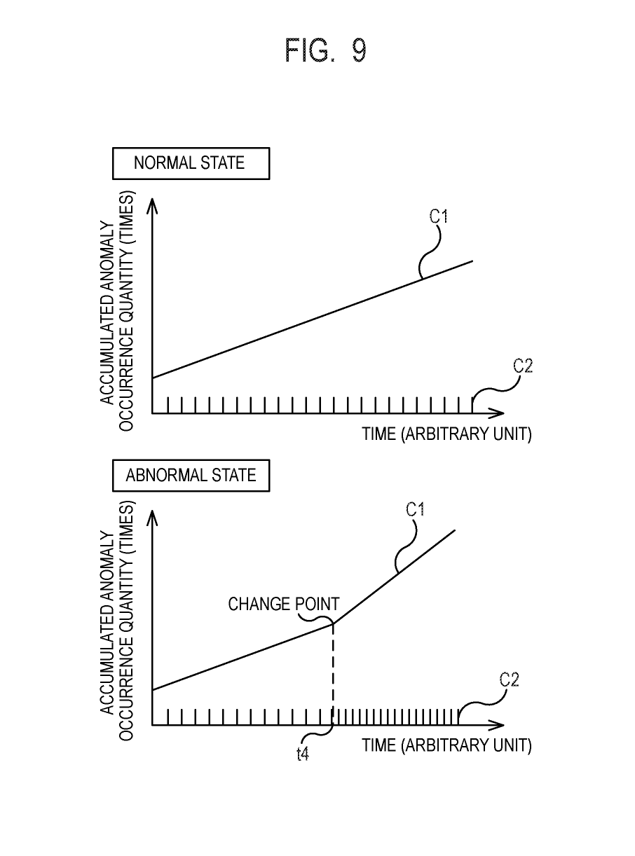

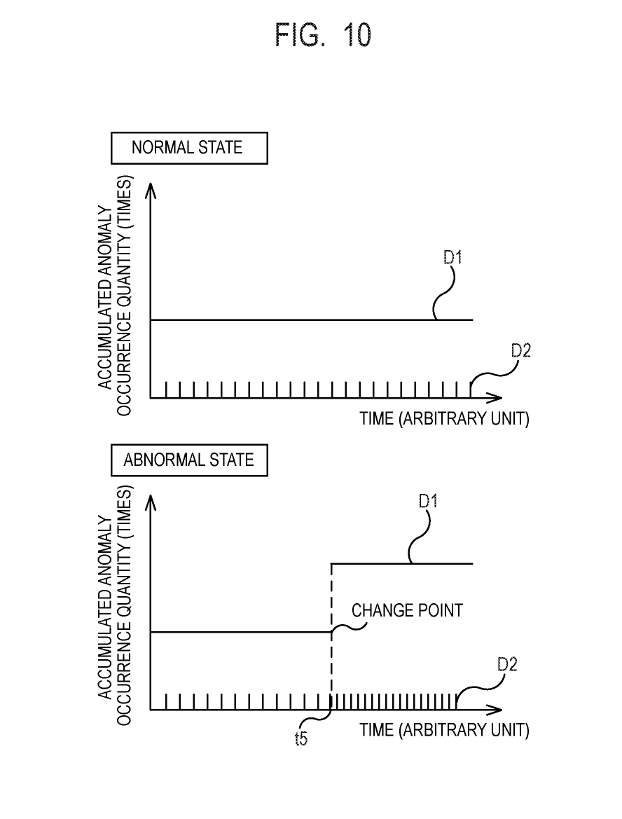

FIG. 9 and FIG. 10 are schematic diagrams of a log analysis method according to the present example embodiment, respectively. While using different types of graphs, FIG. 9 and FIG. 10 illustrate the same log analysis method. In the method of FIG. 9, the detail anomaly analysis unit 240 generates a graph C1 of the accumulated anomaly occurrence quantity resulted by summing the number of abnormal logs determined by the simple anomaly analysis unit 230 by each time (time of day) for each combination of a format and a variable value. In the method of FIG. 10, the detail anomaly analysis unit 240 generates a graph D1 of the anomaly occurrence frequency that is the occurrence frequency per unit time of abnormal logs determined by the simple anomaly analysis unit 230 at each time (time of day) for each combination of a format and a variable value. FIG. 9 and FIG. 10 illustrate distributions C2 and D2 of the output quantity of abnormal logs at each time together with the graphs C1 and D1 of the accumulated anomaly occurrence quantity in a normal state and an abnormal state.

As seen in the upper graphs in FIG. 9 and FIG. 10, even in a normal state, abnormal logs that are output periodically or regularly illustrated in the distributions C2 and D2 are often logs which have simply not been registered as models, for example, and have less importance to be detected as information indicating a cause of an anomaly. In contrast, as seen in the under graphs in FIG. 9 and FIG. 10, a temporary or irregular change occurs in the distributions C2 and D2 in an abnormal state. Since such a temporary or irregular change of the output quantity of abnormal logs often indicates occurrence of an anomaly, the detail anomaly analysis unit 240 according to the present example embodiment detects information indicating a cause of an anomaly based on such a temporary or irregular change of the output quantity of abnormal logs.

To detect a temporary or irregular change in the distributions C2 and D2, the detail anomaly analysis unit 240 according to the present example embodiment detects a change point in the graph C1 of the accumulated anomaly occurrence quantity or the graph D1 of the anomaly occurrence frequency. An inflection point in the graph C1 is used as a change point in the graph C1 of the accumulated anomaly occurrence quantity. As illustrated in the under graph in FIG. 9, occurrence of a temporary or irregular change in the output quantity of abnormal logs causes a discontinuous change in the slope of the graph C1 at a particular time t4. Thus, the detail anomaly analysis unit 240 detects an inflection point at which a change rate of the slope is greater than or equal to a predetermined threshold in the graph C1 for each combination of a format and a variable value. The detail anomaly analysis unit 240 then detects, as information indicating a cause of the anomaly, a combination of a format and a variable value in the graph C1 having an inflection point. The threshold used for detecting an inflection point is appropriately determined by an experiment or a simulation.

A discontinuous point in the graph D1 is used as a change point in the graph D1 of the anomaly occurrence frequency. As illustrated in the under graph in FIG. 10, occurrence of a temporary or irregular change in the output quantity of abnormal logs causes a discontinuous change in the graph D1 at a particular time t5. Thus, the detail anomaly analysis unit 240 detects a discontinuous point at which a change rate is greater than or equal to a predetermined threshold in the graph D1 for each combination of a format and a variable value. The detail anomaly analysis unit 240 then detects, as information indicating a cause of the anomaly, a combination of a format and a variable value in the graph D1 having a discontinuous point. The threshold used for detecting discontinuous point is appropriately determined by an experiment or a simulation.

As discussed above, the detail anomaly analysis unit 240 according to the present example embodiment can detect a temporary or irregular change by using a change point in the graph of the accumulated anomaly occurrence quantity or the anomaly occurrence frequency more accurately than by directly analyzing a distribution itself of the number of abnormal logs. While being combined with the second example embodiment, the present example embodiment may be combined with the first example embodiment. In such a case, the detail anomaly analysis unit 240 may detect information indicating a cause of an anomaly by detecting a change point of the graph of the accumulated log output quantity or the log output frequency.

### Other Example Embodiments

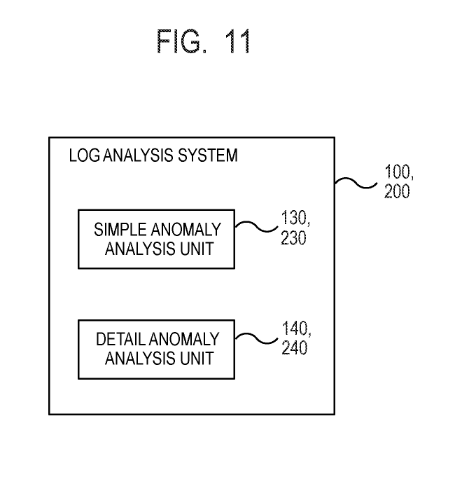

FIG. 11 is a schematic configuration diagram of the log analysis systems 100 and 200 according to respective example embodiments described above. FIG. 11 illustrates a configuration example by which each of the log analysis systems 100 and 200 functions as a device that causes multiple types of analysis to cooperate to analyze an anomaly of logs in a stepwise manner. The log analysis systems 100 and 200 respectively include simple anomaly analysis units 130 and 230 that perform the first analysis to detect an anomaly based on output of logs and the detail anomaly analysis units 140 and 240 that perform the second analysis to analyze the anomaly based on the content of the logs output within a time range including occurrence time of the anomaly detected by the first analysis.

The present invention is not limited to the example embodiments described above and can be properly changed within the scope not departing from the spirit of the present invention.

Further, the scope of each of the example embodiments includes a processing method that stores, in a storage medium, a program that causes the configuration of each of the example embodiments to operate so as to implement the function of each of the example embodiments described above (more specifically, a log analysis program that causes a computer to perform the process illustrated in FIG. 6), reads the program stored in the storage medium as a code, and executes the program in a computer. That is, the scope of each of the example embodiments also includes a computer readable storage medium. Further, each of the example embodiments includes not only the storage medium in which the program described above is stored but also the program itself.

As the storage medium, for example, a floppy (registered trademark) disk, a hard disk, an optical disk, a magneto-optical disk, a CD-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary note 1)

A log analysis method comprising steps of: performing first analysis to detect an anomaly based on output of logs; and

performing second analysis to analyze the anomaly based on contents of the logs output within a time range including occurrence time of the anomaly detected by the first analysis.

(Supplementary note 2)

The log analysis method according to supplementary note 1, further comprising a step of determining which of a plurality of predetermined forms the logs match, each of the forms including a variable part that varies and a constant part that does not vary,

wherein the step of performing the second analysis analyzes the anomaly based on a value of the variable part included in the logs.

(Supplementary note 3)

The log analysis method according to supplementary note 2, wherein the step of performing the second analysis analyzes the anomaly by generating a distribution of the logs for each value of the variable part included in the logs.

(Supplementary note 4)

The log analysis method according to supplementary note 2, wherein the step of performing the second analysis analyzes the anomaly by generating a distribution of the logs for respective combinations of the forms of the logs and values of the variable part included in the logs.

(Supplementary note 5)

The log analysis method according to any one of supplementary notes 1 to 4, wherein the step of performing the first analysis detects the anomaly based on a time-series change in an output quantity or an output frequency of the logs.

(Supplementary note 6)

The log analysis method according to any one of supplementary notes 2 to 4, wherein the step of performing the first analysis detects the anomaly when the logs that do not match any of the forms and values of the variable part that are pre-stored are output.

(Supplementary note 7)

The log analysis method according to supplementary note 6, wherein the step of performing the second analysis generates a time-series graph of the number or a frequency of the logs that do not match any of the forms and the values of the variable part that are pre-stored in the step of performing the first analysis and analyzes the anomaly based on a change point in the graph.

(Supplementary note 8)

A log analysis program that causes a computer to perform steps of:

performing first analysis to detect an anomaly based on output of logs; and

performing second analysis to analyze the anomaly based on contents of the logs output within a time range including occurrence time of the anomaly detected by the first analysis.

(Supplementary note 9)

A log analysis system comprising:

a simple anomaly analysis unit that performs first analysis to detect an anomaly based on output of logs; and

a detail anomaly analysis unit that performs second analysis to analyze the anomaly based on contents of the logs output within a time range including occurrence time of the anomaly detected by the first analysis.

What is claimed is:

1. A log analysis method comprising steps of:
performing first analysis to detect an anomaly based on output of logs; and
performing second analysis to analyze the anomaly based on contents of the logs output within a time range including occurrence time of the anomaly detected by the first analysis.

2. The log analysis method according to claim 1, further comprising a step of determining which of a plurality of predetermined forms the logs match, each of the forms including a variable part that varies and a constant part that does not vary,
wherein the step of performing the second analysis analyzes the anomaly based on a value of the variable part included in the logs.

3. The log analysis method according to claim 2, wherein the step of performing the second analysis analyzes the anomaly by generating a distribution of the logs for each value of the variable part included in the logs.

4. The log analysis method according to claim 2, wherein the step of performing the second analysis analyzes the anomaly by generating a distribution of the logs for respective combinations of the forms of the logs and values of the variable part included in the logs.

5. The log analysis method according to claim 1, wherein the step of performing the first analysis detects the anomaly based on a time-series change in an output quantity or an output frequency of the logs.

6. The log analysis method according to claim 2, wherein the step of performing the first analysis detects the anomaly when the logs that do not match any of the forms and values of the variable part that are pre-stored are output.

7. The log analysis method according to claim 6, wherein the step of performing the second analysis generates a time-series graph of the number or a frequency of the logs that do not match any of the forms and the values of the variable part that are pre-stored in the step of performing the first analysis and analyzes the anomaly based on a change point in the graph.

8. A non-transitory storage medium in which a log analysis program is stored, the log analysis program causing a computer to perform steps of:
performing first analysis to detect an anomaly based on output of logs; and
performing second analysis to analyze the anomaly based on contents of the logs output within a time range including occurrence time of the anomaly detected by the first analysis.

9. A log analysis system comprising:
a simple anomaly analysis unit that performs first analysis to detect an anomaly based on output of logs; and
a detail anomaly analysis unit that performs second analysis to analyze the anomaly based on contents of the logs output within a time range including occurrence time of the anomaly detected by the first analysis.
